(19) United States
(12) Patent Application Publication
(10) Pub. No.: US 2015/0277149 A1
(43) Pub. Date: Oct. 1, 2015

(54) LENS STRUCTURE

(71) Applicant: CHIN-JEN CHEN, TAINAN CITY (TW)

(72) Inventor: CHIN-JEN CHEN, TAINAN CITY (TW)

(21) Appl. No.: 14/228,741

(22) Filed: Mar. 28, 2014

(51) Int. Cl. G02C 7/06

(52) U.S. Cl. CPC G02C 7/06

(57) ABSTRACT

A lens structure includes a plan lens area and an optical lens area which is enclosed by the plan lens area. The optical lens area is located at the upper area of the plan lens area, and the optical lens area is located right above a user's eyesight so that when the user looks upward, the user can see clearly via the optical lens. The lens structure is suitable for those who needs to look upward frequently through the optical lens.

### BACKGROUND OF THE INVENTION

1. Fields of the Invention

The present invention relates to a lens structure, and more particularly, to a lens structure combined with an optical lens and a plan lens, wherein the optical lens is located above the eyesight.

2. Descriptions of Related Art

There are different glasses for providing different functions to treat myopia, hyperopia or astigmatism, there are also glasses for safety and fashion needs such as the safety goggles and sunglasses.

For the safety goggles, most of the googles are equipped with lenses that do not have any corrective function and these lenses are called plano or plan lenses. However, for some of the elder users, far-sightedness (hyperopia) or near-sightedness (myopia) makes the users have to change proper glasses when checking details at short distance or far distance. This is inconvenient for the users due to the frequent changes of the goggles and corrective glasses.

There are some safety goggles equipped with bifocal lenses which mean that the lenses provides the optical correction function that the users need. The bifocal lenses includes a plan lens and an optical lens which is connected to a position of the plan lens. When the lenses are installed to a frame, the optical lens is located beneath the eyesight of the user so that the user can convenient see the details clearly when wearing the safety goggles. Nevertheless, for some users, such as the users who lie on a seat to work, who need to see things located above their eyes frequently, the conventional safety goggles with the conventional bifocal lenses do not meet their needs. In some cases, the optical lens located beneath the eyes can make the vision of the road become blurred when walking.

The present invention intends to provide a lens structure combined with an optical lens and a plan lens, wherein the optical lens is located above the eyesight. The lens structure improves the shortcomings mentioned above.

### SUMMARY OF THE INVENTION

The present invention relates to a lens structure and comprises a plan lens area and an optical lens area which is enclosed by the plan lens area. The optical lens area is located at the upper area of the plan lens area. The optical lens area is located right above a user's eyesight so that when the user looks upward, the user can see clearly via the optical lens. The lens structure is suitable for those who needs to look upward frequently through the optical lens.

Preferably, the optical lens area is located 0 to 10 mm above the eyesight.

Preferably, the diameter of the optical lens area is 5 to 40 mm.

Preferably, the optical lens area uses a concave lens.

Preferably, the optical lens area uses a convex lens.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a pair of glasses with the lens structure of the present invention;

FIG. 2 shows a user wears the pair of glasses with the lens structure of the present invention, and

FIG. 3 shows that the user looks through the optical lens areas of the pair of glasses with the lens structure of the present invention.

### DETAILED DESCRIPTION OF THE PREFERRED EMBODIMENT

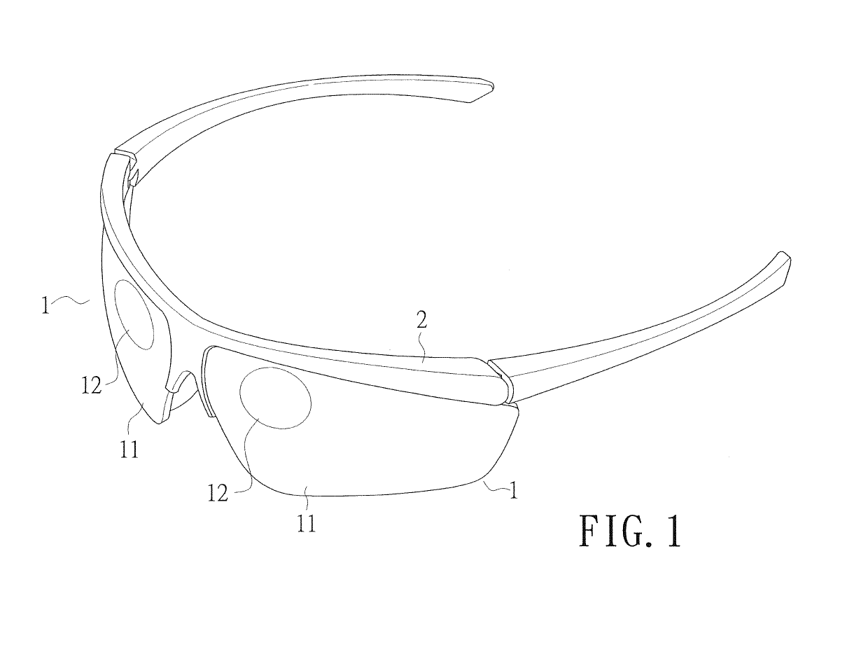

Referring to FIGS. 1 to 3, a lens structure of the present invention comprises a lens 1 having a plan lens area 11 and an optical lens area 12 which is enclosed by the plan lens area 11. The optical lens area 12 is located at the upper area of the plan lens area 11.

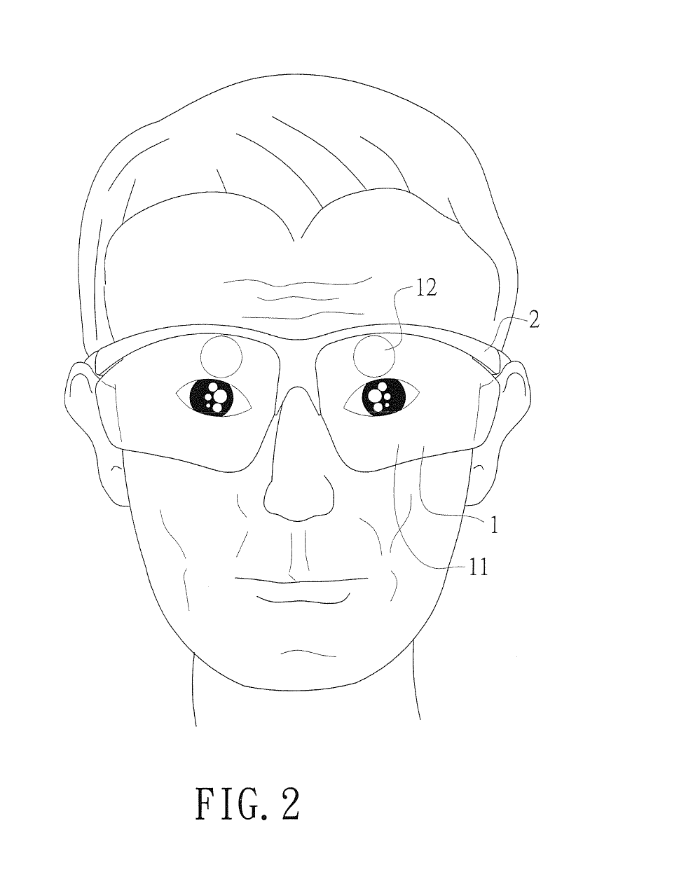

Two lenses 1 are installed to a frame 2 and each lens 1 has a plan lens area 11 and an optical lens area 12 which is enclosed by the plan lens area 11. The optical lens area 12 is located at the upper area of the plan lens area 11. The optical lens area 12 is located right above a user's eyesight as shown in FIG. 2.

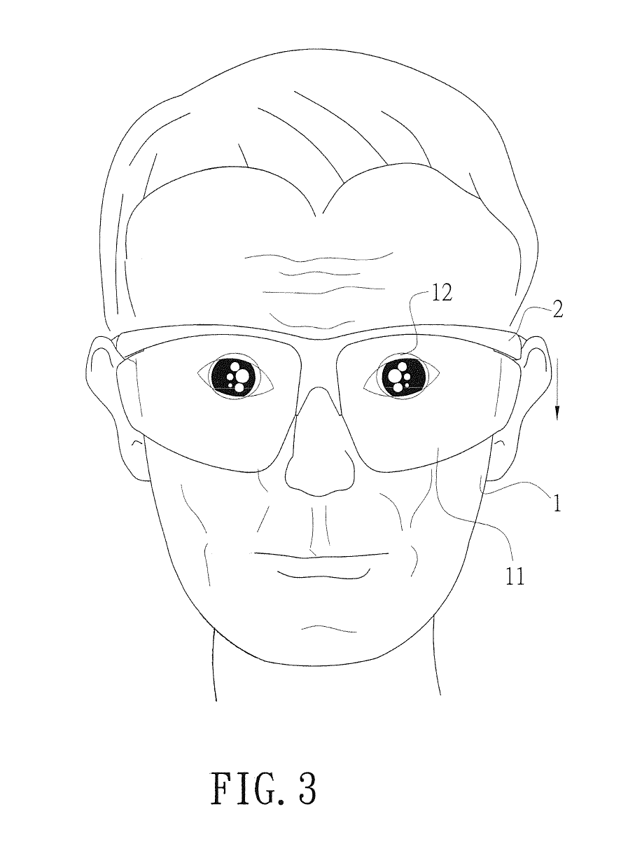

When the user is reading, the user moves the frame 2 downward to allow the eyesight passes through the optical lens areas 12 as shown in FIG. 3. When the user wears the frame 2 with the lenses 1 of the present invention to work such as the user lies on the floor and looks upward to fix an object, the user's eyes look upward through the optical lens areas 12 so that the user can have better vision.

Preferably, the optical lens area 12 uses a concave lens.

Preferably, the optical lens area 12 uses a convex lens.

Preferably, the optical lens area 12 is located 0 to 10 mm above the eyesight.

Preferably, the diameter of the optical lens area 12 is 5 to 40 mm.

The present invention has the following advantages which are that the optical lens area 12 is located right above a user's eyesight so that when the user is stationary and reads books through the plan lens area 11, he/she can get normal reading feature. When in work, the user frequently looks upward, the optical lens areas 12 provide corrective features.

The optical lens area 12 is located right above a user's eyesight so that the users who need to look upward frequently, the optical lens areas 12 provide better and corrective features.

While we have shown and described the embodiment in accordance with the present invention, it should be clear to those skilled in the art that further embodiments may be made without departing from the scope of the present invention.

What is claimed is:

1. A lens structure comprising:
a plan lens area and an optical lens area which is enclosed by the plan lens area, the optical lens area located at an upper area of the plan lens area, the optical lens area located right above a user's eyesight.

2. The lens structure as claimed in claim 1, wherein the optical lens area is located 0 to 10 mm above the eyesight.

3. The lens structure as claimed in claim 1, wherein a diameter of the optical lens area is 5 to 40 mm.

4. The lens structure as claimed in claim 1, wherein the optical lens area uses one of a concave lens and a convex lens.

5. The lens structure as claimed in claim 2, wherein the optical lens area uses one of a concave lens and a convex lens.

6. The lens structure as claimed in claim 3, wherein the optical lens area uses one of a concave lens or a convex lens.
